(19) United States
(12) Patent Application Publication
(10) Pub. No.: US 2014/0177275 A1
(43) Pub. Date: Jun. 26, 2014

(54) LED BACKLIGHT MODULE HAVING REDUCED LIGHT LEAKAGE AND INCREASED LIGHT EXTRACTION EFFICIENCY

(71) Applicant: HON HAI PRECISION INDUSTRY CO., LTD., New Taipei (TW)

(72) Inventor: Chen-Han LIN, New Taipei (TW)

(73) Assignee: HON HAI PRECISION INDUSTRY CO., LTD., New Taipei (TW)

(21) Appl. No.: 13/854,915

(22) Filed: Apr. 1, 2013

(30) Foreign Application Priority Data
Dec. 21, 2012 (TW) 101149090

(51) Int. Cl. F21V 8/00

(52) U.S. Cl. CPC G02B 6/0091
USPC 362/612

(57) ABSTRACT

An LED backlight module includes a light guiding board, a plurality of LED light sources located at an edge side of the light guiding board and a glue layer. The glue layer is located between the edge side of the light guiding board and the LED light sources. The LED light sources are securely attached to the edge side of the light guiding board via the glue layer. The glue layer has a refractive index larger than a refractive index of air.

### BACKGROUND

1. Technical Field

The present disclosure relates to an LED (light emitting diode) backlight module, and more particularly to an LED backlight module for an LCD (light crystal display) panel, which can improve the connection between the LED and the light guiding board, whereby the LED backlight module can have decreased light leakage and increased light extraction.

2. Description of Related Art

LEDs (light emitting diodes) have been widely promoted as light sources of electronic devices owing to many advantages, such as high luminosity, low operational voltage and low power consumption. An LED backlight module of an LCD (liquid crystal display) panel includes a light guiding board and a plurality of LED light sources located at one edge side of the light guiding board. The plurality of LED light sources is fixed to a bottom of a U-shape frame which has two lateral sides attached to upper and lower faces of the light guiding board by adhesive. An air gap is defined between the plurality of LED light sources and the edge side of the light guiding board, so a part of the light emitted by the plurality of LED light sources which has a large emitting angle will be lost in the air gap, whereby a light leakage is formed and the utilization rate of the light of the LED light sources is decreased. Furthermore, due to the air gap which has a low refractive index, a total internal reflection can easily occur at an interface between the LED light sources and the air gap, whereby light extraction efficiency is low.

Therefore, an LED backlight module capable of overcoming the above described shortcomings is desired.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows a schematic view of a backlight module in accordance with an embodiment of the present disclosure.

FIG. 2 shows a cross-sectional view of the backlight module of FIG. 1, taken along a line II-II thereof.

FIG. 3 shows an enlarged view of part III of FIG. 2.

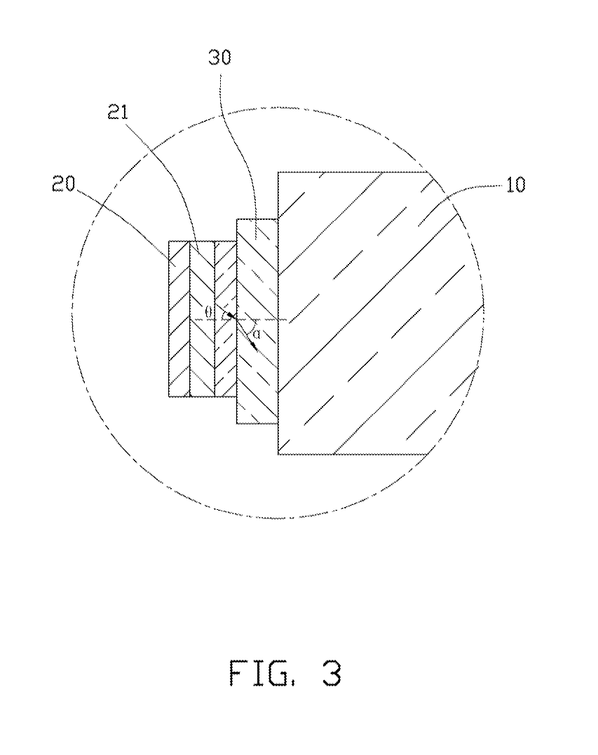

### DETAILED DESCRIPTION

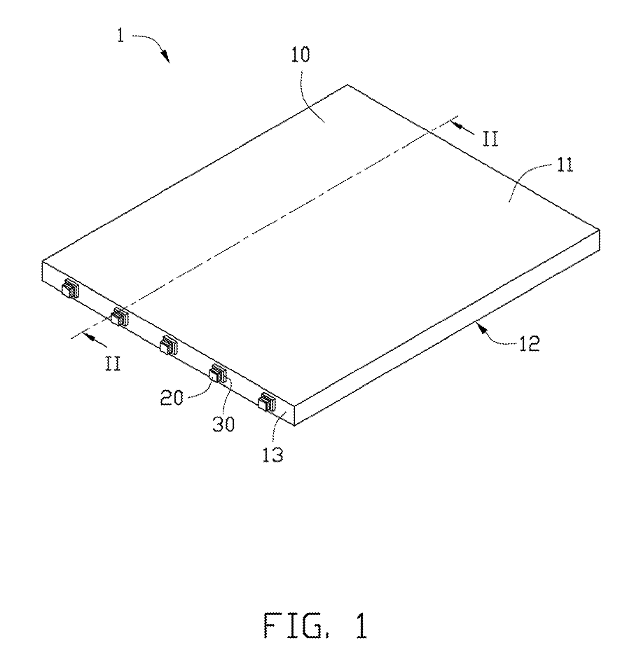

Referring to FIG. 1, a backlight module 1 in accordance with an exemplary embodiment of the present disclosure includes a light guiding board 10, a plurality of LED light sources 20 located at a lateral edge side 13 of the light guiding board 10 and a glue layer 30 located between the light guiding board 10 and the LED light sources 20. The LED light sources 20 are attached to the light guiding board 10 via the glue layer 30.

The light guiding board 10 is a thin and flat board. The light guiding board 10 includes an upper face 11, a lower face 12 opposite to the upper face 11, and four edge sides 13 interconnecting the upper face 11 and the lower face 12. In this embodiment, the edge sides 13 each are perpendicular to the upper face 11 and the lower face 12. The upper face 11 is a light output face for outputting light to an LCD panel (not shown), while the lower face 12 is a light reflecting face. An area of each of the upper and lower faces 11, 12 is quite larger than an area of each of the edge sides 13.

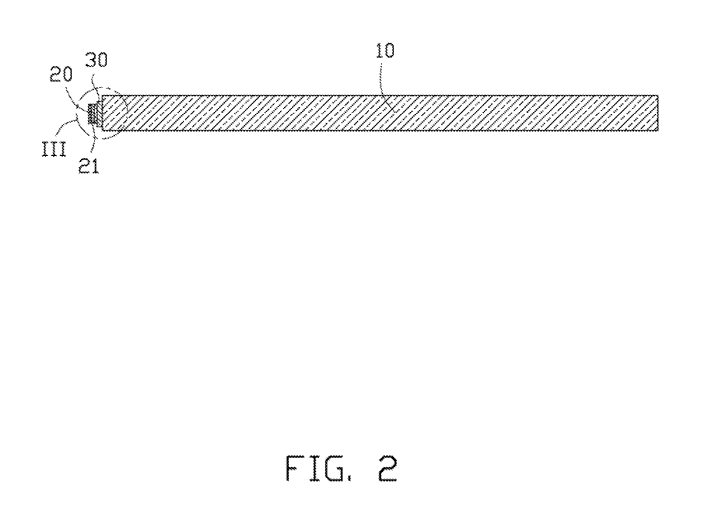

Referring to FIG. 2, the LED light sources 20 are attached to one corresponding edge side 13 of the light guiding board 10 via the glue layer 30. Each of the LED light sources 20 includes a luminescent layer 21 therein. In this embodiment, the number of the LED light sources 20 is five.

It is to be understood that the LED light sources 20 can be attached to one or more of the other edge sides 13.

The initial state of the glue layer 30 is gelatinous, and the glue layer 30 is solidified when it is heated or irradiated by ultraviolet light.

In use of the backlight module 1, light emitted from the luminescent layer 21 of the LED light source 20 is transmitted in the glue layer 30, and is refracted. Then, an incident angle thereof is defined as θ, an refraction angle thereof is defined as α, and a critical angle of total reflection thereof is defined as β. When α is equal to 90°, θ is equal to β, and the light will be output. When θ>β, the light will be reflected back into the interior of the LED light source 20 without being output. When θ<β, α<90°, the light would be totally output. According to the theory of refraction of light, N₁ sin θ=N₂ sin α, wherein N₁ is value of refraction of the LED light source 20, and N₂ is value of refraction of the glue layer 30. When α is equal to 90°, θ is equal to β, so N₁ sin β=N₂, further sin β=N₂/N₁. For N₂ is greater than value of refraction of air, when the light emitted from the luminescent layer 21 passes through the glue layer 30, β is greater than a critical angle of total reflection when the light is directly transmitted towards the air, so the light which cannot travel out for total reflection when the LED light source 20 touches with the air can be refracted towards the glue layer 30 on an interface located between the LED light source 20 and the glue layer 30, further refracted towards the light guiding board 10. Therefore, the loss of light is low, and the efficiency of utilization of the backlight module 1 is enhanced. Additionally, for the initial glue layer 30 being gel, and the glue layer 30 being solidified when it is heated or is radiated by ultraviolet light, the light guiding board 10 is firmly connected to the LED light sources 20, and no air gap is defined between the light guiding board 10 and the LED light sources 20, so the light guiding board 10 and the LED light sources 20 are combined closely whereby the light generated by the LED light sources 20 can be totally emitted into the light guiding board 10.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A backlight module, comprising:
a light guiding board;
a plurality of LED light sources located at an edge side of the light guiding board; and
a glue layer located between the edge side of the light guiding board and the LED light sources to securely mount the LED light sources to the edge side of the light guiding board;
wherein the glue layer has a refractive index larger than a refractive index of air.

2. The backlight module of claim 1, wherein the glue layer is gelatinous in an initial state, and the glue layer is solidified after it is heated to securely mount the LED light sources to the edge side of the light guiding board

3. The backlight module of claim 1, wherein the glue layer is gelatinous in an initial state, and the glue layer is solidified after it is radiated by ultraviolet light to securely mount the LED light sources to the edge side of the light guiding board.

4. The backlight module of claim 1, wherein the light guiding board comprises an upper face and a lower face opposite to the upper face, the edge side interconnecting the upper face and the lower face, an area of each of the upper face and the lower face being larger than an area of the edge side, wherein the upper face is a light output face and the lower face is a light reflecting face.

5. The backlight module of claim 1, wherein each of the LED light sources comprises a luminescent layer therein.
